(19) United States
(12) Patent Application Publication
(10) Pub. No.: US 2015/0206082 A1
(43) Pub. Date: Jul. 23, 2015

(54) IDENTIFYING EMPLOYEE CAPACITY ISSUES

(71) Applicant: Bank of America Corporation, Charlotte, NC (US)

(72) Inventors: Gayathri Rao Sarvepalle, Hyderabad (IN); Leena Mahavar, Hyderabad (IN); Shantanu Singh, Haryana (IN); Tanveer Sajanlal, Hyderabad (IN); Sandeepan Thapliyal, Ghaziabad (IN)

(73) Assignee: Bank of America Corporation, Charlotte, NC (US)

(21) Appl. No.: 14/158,023

(22) Filed: Jan. 17, 2014

(51) Int. Cl. G06Q 10/06; G06Q 10/10

(52) U.S. Cl. CPC G06Q 10/06313; G06Q 10/105; G06Q 40/02

(57) ABSTRACT

Methods, systems, computer-readable media, and apparatuses for identifying employee capacity issues for performing document review are presented. In some embodiments, a computing device may categorize delegations of authority for a plurality of employees. Subsequently, the computing device may group a volume of documents into a plurality of groups by their monetary value. The computing device may then calculate the required employee capacity and the actual employee capacity available to assess each group of documents. Subsequently, the computing device may compare the actual employee capacity with the required employee capacity for each group of documents and determine, based on the comparison, whether a difference exists between the actual employee capacity and the required employee capacity. In response to determining that a difference exists, the computing device may provide one or more resolution.

### BACKGROUND

Aspects of the disclosure relate to computer hardware and software. In particular, one or more aspects of the disclosure generally relate to computer hardware and software for identifying employee capacity issues for performing document review.

Financial documents, such as letters of credit, are commonly exchanged in business. Such financial documents have to be reviewed by a financial institution to verify that they follow various predefined guidelines including standard letters of credit requirements and the rules and regulations of privacy. A financial institution may provide services to a number of geographic regions and may process financial documents within each region. The documents may be received at each location either at a predetermined time of day or week (e.g., on a fixed schedule), or the documents may be received at each location at a varying time of day and week (e.g., on a variable schedule). Upon receiving the financial documents for review, the financial institution may group the documents based on their monetary value. Each group of documents may then be reviewed by individuals who have a requisite level of authority to review those documents. The review of documents at different geographic locations, coupled with employees having limited authority as to what documents they are able to review may cause discrepancies in scheduling the correct number of employees for conducting document review.

### SUMMARY

Aspects of the disclosure provide effective, efficient, and convenient ways of identifying employee capacity issues for performing a review of documents having a defined monetary value. In particular, certain aspects of the disclosure provide techniques for identifying and calculating employee capacity issues for performing document checks of groups of documents, where employees reviewing each group of documents require a predefined level of authority.

For example, some aspects of the disclosure provide ways of categorizing delegations of authority for a plurality of employees, as well as grouping a volume of documents into a plurality of groups by monetary value. Subsequently, a computing device will calculate a required employee capacity to assess each group of documents and an actual employee capacity to assess each group of documents. The computing device will then compare the actual employee capacity with the required employee capacity for each group of documents and determine whether a difference exists between the actual employee capacity and the required employee capacity for each group of documents.

By providing processing engines and a predictive model for measuring employee capacity in accordance with one or more aspects of the disclosure, an organization may better enable the scheduling of employees for conducting a review of financial documents, including correctly distributing the number of employees with varying levels of authority. For instance, by having a processing engine identify employee capacity discrepancies, as discussed below, an organization may better identify the number of employees having specific levels of authority needed for reviewing received financial documents having a certain monetary value at various times of day.

Thus, in some embodiments discussed below, a processing engine (which may, e.g., be executed on and/or by one or more computing devices) may group a volume of documents into a plurality of groups by monetary value. Each group of documents may coincide with a corresponding authorization level for assessment of those documents. The authorization level for each corresponding group of documents cascades to all groups of documents having a monetary value below the corresponding group of documents. For example, an individual having authority to review documents having a monetary value of one million to ten million may also review all documents having a monetary value less than ten million, but that same individual might not have the authority to review documents having a monetary value above ten million. Subsequently, the processing engine may calculate a required employee capacity (e.g., the number of employees needed to review a certain volume of documents) and an actual employee capacity (e.g., the number of available employees to conduct a review of the volume of documents) for assessing each group of documents. The calculation of the required employee capacity may be based on predetermined document handling times, where the predetermined document handling time may be a value derived from historical data collected by a computing device.

In some instances, the processing engine may enable one or more resolution actions to be executed in response to determining that a difference exists between the required employee capacity and the actual employee capacity. The resolution actions may, in some instances, include issuing an alert, generating a graphical snapshot of the identified difference between the actual employee capacity and the required employee capacity, suggesting supplemental employee capacity for assessing each group of documents, collecting historical data of any identified difference, and/or the like.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1A illustrates an example operating environment in which various aspects of the disclosure may be implemented;

FIG. 1B illustrates another example operating environment in which various aspects of the disclosure may be implemented;

FIG. 2 illustrates an example of a system for identifying employee capacity issues according to one or more embodiments;

FIG. 3 illustrates a flowchart that depicts a method of identifying employee capacity issues according to one or more embodiments; and

FIG. 4 illustrates an example of a user interface that may be displayed in providing status information about employee capacity issues in one or more embodiments.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

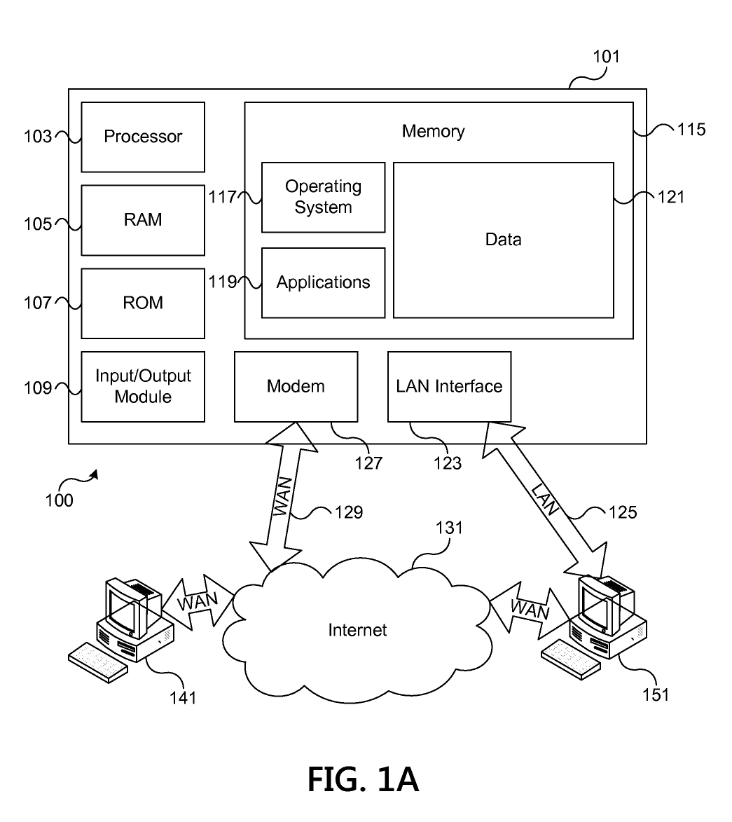

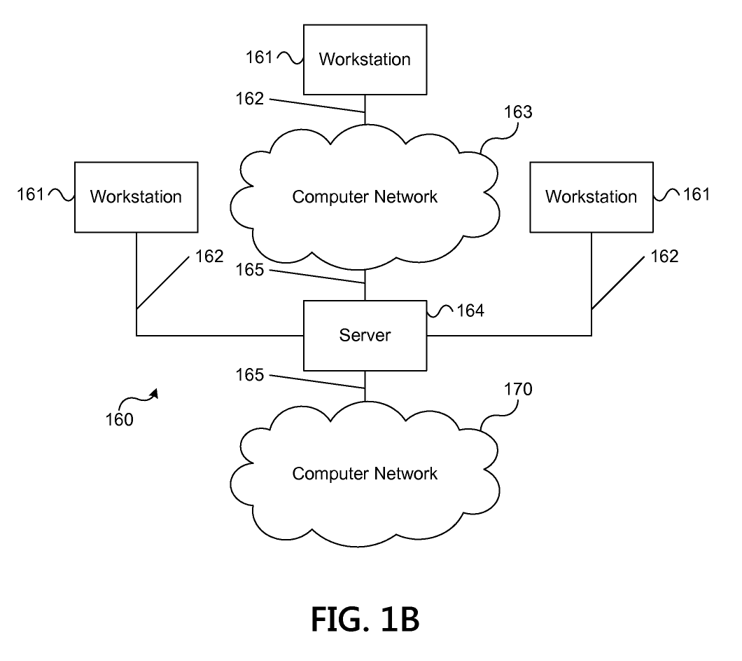

As noted above, certain embodiments are discussed herein that relate to identifying employee capacity issues for performing a review of documents having a monetary value. Before discussing these concepts in greater detail, however, an example of a computing device that can be used in implementing various aspects of the disclosure, as well as an example of an operating environment in which various embodiments can be implemented, will first be described with respect to FIGS. 1A and 1B.

FIG. 1A illustrates an example block diagram of a generic computing device 101 (e.g., a computer server) in an example computing environment 100 that may be used according to one or more illustrative embodiments of the disclosure. The generic computing device 101 may have a processor 103 for controlling overall operation of the server and its associated components, including random access memory (RAM) 105, read-only memory (ROM) 107, input/output (I/O) module 109, and memory 115.

I/O module 109 may include a microphone, mouse, keypad, touch screen, scanner, optical reader, and/or stylus (or other input device(s)) through which a user of generic computing device 101 may provide input, and may also include one or more of a speaker for providing audio output and a video display device for providing textual, audiovisual, and/or graphical output. Software may be stored within memory 115 and/or other storage to provide instructions to processor 103 for enabling generic computing device 101 to perform various functions. For example, memory 115 may store software used by the generic computing device 101, such as an operating system 117, application programs 119, and an associated database 121. Alternatively, some or all of the computer executable instructions for generic computing device 101 may be embodied in hardware or firmware (not shown).

The generic computing device 101 may operate in a networked environment supporting connections to one or more remote computers, such as terminals 141 and 151. The terminals 141 and 151 may be personal computers or servers that include many or all of the elements described above with respect to the generic computing device 101. The network connections depicted in FIG. 1A include a local area network (LAN) 125 and a wide area network (WAN) 129, but may also include other networks. When used in a LAN networking environment, the generic computing device 101 may be connected to the LAN 125 through a network interface or adapter 123. When used in a WAN networking environment, the generic computing device 101 may include a modem 127 or other network interface for establishing communications over the WAN 129, such as the Internet 131. It will be appreciated that the network connections shown are illustrative and other means of establishing a communications link between the computers may be used. The existence of any of various well-known protocols such as TCP/IP, Ethernet, FTP, HTTP, HTTPS, and the like is presumed.

Generic computing device 101 and/or terminals 141 or 151 may also be mobile terminals (e.g., mobile phones, smartphones, PDAs, notebooks, and so on) including various other components, such as a battery, speaker, and antennas (not shown).

The disclosure is operational with numerous other general purpose or special purpose computing system environments or configurations. Examples of well-known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

FIG. 1B illustrates another example operating environment in which various aspects of the disclosure may be implemented. As illustrated, system 160 may include one or more workstations 161. Workstations 161 may, in some examples, be connected by one or more communications links 162 to computer network 163 that may be linked via communications links 165 to server 164. In system 160, server 164 may be any suitable server, processor, computer, or data processing device, or combination of the same. Server 164 may be used to process the instructions received from, and the transactions entered into by, one or more participants.

According to one or more aspects, system 160 may be associated with a financial institution, such as a bank. Various elements may be located within the financial institution and/or may be located remotely from the financial institution. For instance, one or more workstations 161 may be located within a branch office of a financial institution. Such workstations may be used, for example, by customer service representatives, other employees, and/or customers of the financial institution in conducting financial transactions via network 163. Additionally or alternatively, one or more workstations 161 may be located at a user location (e.g., a customer's home or office). Such workstations also may be used, for example, by customers of the financial institution in conducting financial transactions via computer network 163 or computer network 170.

Computer network 163 and computer network 170 may be any suitable computer networks including the Internet, an intranet, a wide-area network (WAN), a local-area network (LAN), a wireless network, a digital subscriber line (DSL) network, a frame relay network, an asynchronous transfer mode network, a virtual private network (VPN), or any combination of any of the same. Communications links 162 and 165 may be any communications links suitable for communicating between workstations 161 and server 164, such as network links, dial-up links, wireless links, hard-wired links, and/or the like.

Having described an example of a computing device that can be used in implementing various aspects of the disclosure and an operating environment in which various aspects of the disclosure can be implemented, several embodiments will now be discussed in greater detail. As introduced above, some aspects of the disclosure generally relate to identifying employee capacity issues for performing document checks. In the discussion below, various examples illustrating how employee capacity issues may be identified using a processing engine in accordance with one or more embodiments will be provided.

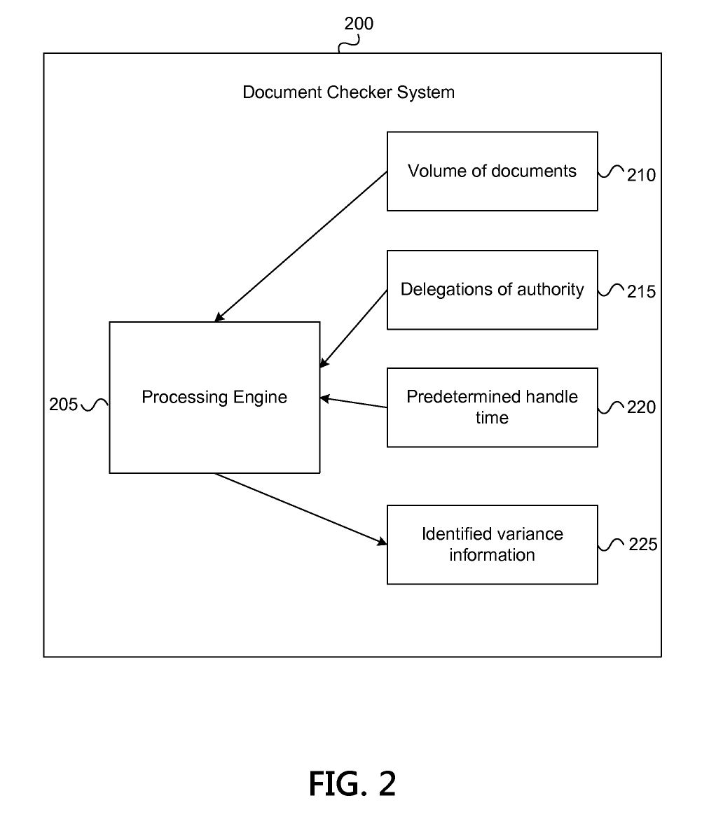

FIG. 2 illustrates an example of a system 200 for identifying employee capacity issues for performing document checks according to one or more embodiments. In some embodiments, system 200 and/or its sub-elements, such as processing engine 205, may be implemented in one or more computing devices, which may include and/or incorporate one or more processors, one or more memories, and/or one or more aspects of the computing device 101 discussed above. In some instances, system 200 may include a number of different subsystems, databases, and/or libraries. In some arrangements, all of the databases included in system 200 may be included in and/or incorporated into a single computing device, while in other arrangements, each database included in system 200 (and/or combinations thereof) may be included in and/or incorporated into a distinct and/or dedicated computing device.

As seen in FIG. 2, in some embodiments, document check system 200 may include a processing engine 205. Processing engine 205 may be configured to receive various types of information, such as information regarding a volume of documents 210, delegations of employee authority 215, and predetermined document handling times 220. Processing engine 205 may be configured to send and/or exchange various types of information with one or more other devices, which may include issuing an alert regarding an identified variance 225. For instance, processing engine 205 may be configured to issue an alert in response to an identified variance 225 based on and/or in response to discrepancies in available employee capacity compared to needed employee capacity. This arrangement represents one example configuration of system 200. In other embodiments, one or more elements of system 200 may be combined and/or additional and/or alternative types of information and/or requests may be included and/or handled in addition to and/or instead of those shown in FIG. 2.

In some embodiments, processing engine 205 may be configured to collect and process information. In one or more arrangements, the information that is collected and/or processed by processing engine 205 may include a volume of documents 210. The volume of documents may be financial documents (e.g., lines of credit) having a monetary value. The volume of documents received may be sorted and grouped by the monetary value (e.g., grouped by a monetary value of 0-50 k, 50 k-100 k, 100 k-200 k, 200 k-250 k, 250 k-500 k, 500 k-1M, 1M-10M, or greater than 10M). Each group of documents is subject to review to confirm that the documents satisfy various standard criteria. Each group of documents may require a specific level of authority on the part of a document reviewer, who might need to have the requisite level of authority in order to review the particular group of documents.

The volume of documents may be received from a variety of geographic locations. For example, documents may be localized to certain geographic regions (e.g., United States, Asia and Europe, the Middle East, and Africa (collectively, “EMEA”)). Additionally, the documents may be received at a fixed date and time. Alternatively, the volume of documents may be received at varying dates and times. In some instances, at each location, the volume of documents received may vary from day to day. For example, fifty documents may be received at a first geographic region document review location on a first day and thirty documents may be received at the first geographic region document review location on a second day. In certain situations, the reliability of document delivery may be dependent on the geographic region the documents are being received from. For example, documents received within the first geographic region may be more likely to be received at a predictable time of day, every day. In contrast, documents received within a second geographic region may be received more sporadically. For example, documents may be received at a first geographic region document review location at 21:00 EST each day and, in comparison, documents may be received at a second geographic region document review location at 19:00 EST a first day and at 23:00 EST a second day.

Processing engine 205 may also be configured to collect and process information regarding delegations of authority 215. In some instances, a delegation of authority may be a level of authorization applied to individuals signifying that those individuals are qualified to conduct a review of financial documents having a certain monetary value. For example, some individuals may have the authority to review documents having a monetary value up to ten million, but might not be authorized to review documents having a monetary value above ten million. In some instances, processing engine 205 may receive a list of employees identifying the authority level of each employee. The list of employees may be updated daily so as to capture which employees are available on each day. In some instances, the employee list may be updated manually. The list of employees identifying the authority level of each employee may also identify if an employee is authorized to perform a single check of documents or a dual check of documents. In additional embodiments, subject matter experts, managers, and/or the like may be identified on the employee list. Subject matter experts and managers may have the highest level of authority (e.g., may have an authority level that allows for review of documents having any monetary value).

In some embodiments, processing engine 205 may also be configured to collect and process information regarding predetermined handling times 220. Predetermined handling times may be the calculated amount of time for a financial document to be reviewed. In some instances, the predetermined handling time may be calculated by utilizing historic metric data of document processing. The metric data may include data on the amount of time it takes an employee to process documents having a certain monetary value. In certain instances, the predetermined handling time may be calculated using a weighted average handle time. The weighted average handle time may be calculated based on the average handle time and the average monthly volume of documents in view of a specified number of full time employees. In some instances, the predetermined handling time may be for a single check of the documents or, alternatively, may be for a dual check of the documents. In certain instances, a single check of the documents may be a weighted average time of all processes. In other instances, a dual check (e.g., a first review of the documents followed by a second review of the documents) handle time is calculated as the single check handle time less ten minutes. In some instances, the first review of the documents of a dual check may be performed by a first employee, and the second review of the documents of a dual check may be performed by a second employee.

In some embodiments, processing engine 205 may receive predetermined handling time information from another system (e.g., a handling time monitoring and calculation system). Additionally or alternatively, processing engine 205 may receive historic metric data (which may include, e.g., average document handling time, average monthly document volume, number of employees conducting document review of a group of documents, weighted average time and/or the like) and calculate predetermined handling times 220 itself. For instance, some computing devices may be configured to periodically report information about the review of documents, and document checker system 200 may be configured to receive these periodic reports (e.g., hourly, daily, weekly, monthly, and so on) and store the information as predetermined handling time information (which may, e.g., enable processing engine 205 to identify any variances in employment capacity using relatively up-to-date predetermined document handling time information).

In some instances, processing engine 205 may be further configured to identify one or more variances 225 in response to processing information including a volume of documents 210, delegations of authority 215, predetermining handling times 220, and the like. Processing engine 205 may, for instance, identify one or more variances in the number of employees authorized to conduct a document review. Processing engine 205 may, for instance, identify an excess of employees available to conduct a review of a group of documents. Additionally or alternatively, processing engine 205 may, for instance, identify a deficit of employees available to conduct a review of a group of documents. In still other instances, processing engine 205 may identify an excess of employees having the authority to conduct a review of a first group of documents, as well as a deficit of employees having the authority to conduct a review of a second group of documents. For example, in identifying variances 225 and subsequently providing them to a financial institution, the processing engine 205 may analyze the information received regarding a document check system. In performing this analysis, the processing engine 205 may produce a list of document groups exhibiting a variance between the number of employees available and authorized to conduct the document review and the number of employees actually required to conduct the document review.

As indicated above, these are examples of the elements that may be included in system 200 in some embodiments, as well as some of the functions that may be performed (e.g., by system 200). In other embodiments, additional and/or other elements may similarly be included and/or other functions may be performed, in addition to and/or instead of those discussed above.

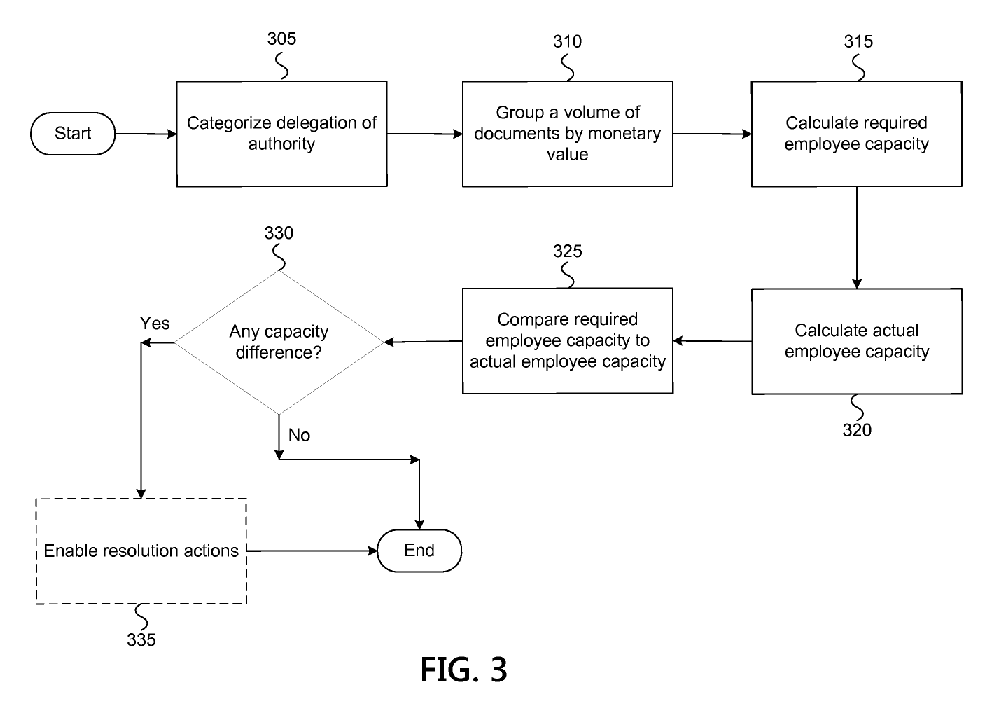

Having described an example system that may be used in identifying employee capacity issues for performing document checks in some embodiments, an example of a method that may, in some embodiments, be performed (e.g., by such a system 200; by another computing device, such as computing device 101; and/or the like) will now be discussed in greater detail with respect to FIG. 3.

FIG. 3 illustrates a flowchart that depicts a method of identifying employee capacity issues for performing document checks of financial documents according to one or more embodiments. In some embodiments, the example method illustrated in FIG. 3 may be performed by a computing device, which may include and/or implement one or more aspects of computing device 101. In additional and/or alternative embodiments, the example method illustrated in FIG. 3 may be performed by a computer system, such as system 200. In other embodiments, the example method illustrated in FIG. 3 may be implemented in and/or may otherwise be embodied in computer-readable instructions that may be stored in a computer-readable medium, such as a memory.

As seen in FIG. 3, the method may be initiated in step 305, in which delegations of authority for a plurality of employees may be categorized. For example, in step 305, a computing device (e.g., computing device 101, system 200, and/or the like) may categorize delegations of authority for a plurality of employees. The delegations of authority categorized in step 305 may, for instance, include varying levels of authority for conducting review of documents. In categorizing the delegations of authority, the computing device may, for example, classify a plurality of employees as having individual levels of authority for conducting document review. Each employee may be assigned a specific level of authority to review documents having a defined monetary value (e.g., an employee may be authorized to review documents having a monetary value up to ten million, but might not be authorized to review any documents having a higher monetary value). In some instances, employees may be indicated as having both a level of authority, as well as having the authority to perform a single check of documents. In certain instances, employees may be indicated as having the authority to perform a portion of a dual check of the documents (e.g., to perform a first review or a second review of the documents). The computing device may refresh the categorization of the delegations of authority every day (e.g., the categorizations will be refreshed in view of changes to the employee schedule).

In step 310, a volume of documents may be grouped. For example, in step 310, the computing device may group a volume of documents into a plurality of groups by monetary value. The volume of documents may be a plurality of financial documents (e.g., letters of credit, documents used in trade finance, and/or the like). Each document may have a certain monetary value (e.g., a dollar amount for a line of credit). In some instances, the documents may be grouped by the monetary value of each document. For example, various monetary value ranges may be identified and each document may be grouped within each range (e.g., document values may be identified and documents may be grouped within one of the following ranges 0-50 k, 50 k-100 k, 100 k-200 k, 200 k-250 k, 250 k-500 k, 500 k-1M, 1M-10M, and/or over 10M).

In some embodiments, each group of documents may have a corresponding level of authorization for employees who conduct the assessment of the documents (e.g., an employee may be designated as having authority to review all documents having a monetary value within a range of 5-10M). The authorization level for each corresponding group of documents may cascade or filter down to all groups of documents having a monetary value below the corresponding group of documents. For example, if an employee has an authorization level allowing for review of documents having a monetary value of one million to ten million, that same employee is also authorized to review all documents having a monetary value below one million. However, that same employee might not be authorized to review documents having a monetary value above ten million.

In step 315, a required employee capacity may be calculated. For example, in step 315, the computing device may calculate a required employee capacity to assess each group of documents grouped in step 310. A required employee capacity is the number of employees necessary to perform the review of the grouped documents. For example, it may be calculated that five authorized employees would be needed to review a total of fifty financial documents having a monetary value of 5M-10M. In some instances, the required employee capacity may be calculated for each individual group of documents. Additionally or alternatively, the required employee capacity may be calculated for conducting a review of a total volume of documents.

In some instances, the calculated required employee capacity of step 315 may be based on a predetermined document handling time. The predetermined document handling time is the projected time required by an employee to complete a review of a financial document. The predetermined document handling time for each group of documents may be derived from historical data. In some instances, the predetermined document handling time may be calculated by a computing device. In alternative embodiments, the predetermined document handling time may be calculated by a handling time monitoring and calculation system and transmitted to a computing device. The predetermined document handling time may be continuously updated in view of historical data being continuously collected and aggregated. In some instances, the updated predetermined document handling time may be transmitted to a computing device daily for the calculation of the required employee capacity.

In step 320, an actual employee capacity may be calculated. For example, in step 320, the computing device may calculate an actual employee capacity to assess each group of documents grouped in step 310. An actual employee capacity is the number of employees actually at the reviewing location and authorized to conduct a review of the documents. For example, it may be calculated that there are three employees scheduled at the document review location who are authorized to review a group of fifty financial documents having a monetary value of 5M-10M. In some instances, the actual employee capacity may be calculated for each individual group of documents. Additionally or alternatively, the actual employee capacity may be calculated for conducting a review of a total volume of documents.

In some instances, the actual employee capacity may be measured by an employee list of the available employees on any given day. An employee list may identify the authorization level for each employee. Additionally, the employee list may include the availability of each employee over a twenty-four hour period. In some instances, the employee list may be updated on a daily basis as to the number of employees available and what their authorization level is. In certain instances, the employee list may be updated manually and transmitted to the computer system daily. Alternatively, the employee list may be updated by an employee scheduling system and may be transmitted to the computer system daily.

In step 325, the actual employee capacity and the required employee capacity may be compared. For example, in step 325, the computing device may compare the actual employee capacity calculated in step 320 and the required employee capacity calculated in step 315 for each group of documents grouped in step 310. Additionally and/or alternatively, the required employee capacity and the actual employee capacity may be compared for conducting a review of a total volume of documents received.

In step 330, a difference between the actual employee capacity and the required employee capacity may be determined. For example, in step 330, the computing device may determine whether a difference between the actual employee capacity calculated in step 320 and the required employee capacity calculated in step 315 for each group of documents grouped in step 310 exists. In some instances, the actual employee capacity may be measured against the required employee capacity identifying any difference that may exist regarding the number of employees who are needed to review each group of documents. In certain instances, an excess of employees may be identified for reviewing a group of documents (e.g., there are more authorized employees to conduct the document review than are actually needed). In alternative instances, a deficit of employees may be identified for reviewing a group of documents (e.g., there are not enough authorized employees to conduct the necessary document review). For example, a group of fifty financial documents having a monetary range of 5M-10M may be calculated as requiring five authorized employees to review the documents, but in actuality there are only three available employees with the correct authorization level to conduct the review, and therefore there is a deficit in the number of employees to provide the document review. Additionally or alternatively, the actual employee capacity and the required employee capacity may be compared for a total volume of documents received, and any difference may be identified.

In step 335, one or more resolution actions may be enabled. For example, in step 335, the computing device may enable one or more resolution actions in response to determining that a difference exists as established in step 330. In some instances, a difference may be identified between the number of required employees and the number of actual employees for providing a review of documents (e.g., a deficit or an excess of employees). One or more resolution actions may be enabled in response to a deficit of actual employees authorized from the required number of authorized employees. Additionally or alternatively, one or more resolution actions may be enabled in response to an excess of employees authorized for providing document review services for a group of documents.

In some arrangements, enabling the one or more resolution actions in step 335 may include at least one of issuing an alert (which may include, e.g., an instant message, an SMS message, an e-mail and/or the like to notify that a difference in employee capacity exists), generating a graphical snapshot of the identified difference between the actual employee capacity and the required employee capacity (which may include, e.g., a pie chart, a graph, a plot and/or the like), suggesting supplemental employee capacity for assessing each group of documents (which may include, e.g., identifying managers, subject matter experts and/or the like who are authorized to assess documents having any monetary value), rescheduling employees to review documents corresponding to a different authorization level (which may include, e.g., rescheduling excess employees authorized to review documents having a certain monetary value to instead review documents having a monetary value less than the monetary value initially authorized for), and collecting historical data of any identified difference (which may include, e.g., providing hiring and scheduling recommendations to address capacity issues).

In some arrangements, the information generated by the computing device may be collected and aggregated. Such information may be used to identify trends in employment capacity and provide for more informed hiring decisions. For example, repeated instances of having an excess or a deficit of employees authorized to perform document review may be identified. In certain aspects, repeated instances of having an excess or a deficit of employees having a certain authority level may also be identified (e.g., there is repeatedly a deficit of employees who are authorized to review documents having a monetary value of 5M-10M). Such information may be utilized in making employment decisions regarding the increasing or decreasing of the number of employees having certain levels of authorization. In other instances, the information generated may be utilized to schedule training for employees so as to change the level of authorization for that employee. Alternatively, excess employees of a certain authorization level may be relocated to another location or document review team. In still other embodiments, the number of authorized employees scheduled at different times of day may be adjusted in view of when a volume of documents is received.

Subsequently, the method may end. As illustrated in the examples above, however, certain aspects of the identification of employee capacity issues may be repeated (e.g., in receiving, updating and continuing to aggregate employee capacity information and document volume information). Additionally or alternatively, the decision engine may perform similar steps as those illustrated in FIG. 3 and discussed above in identifying employee capacity issues for performing document review of groups of financial documents.

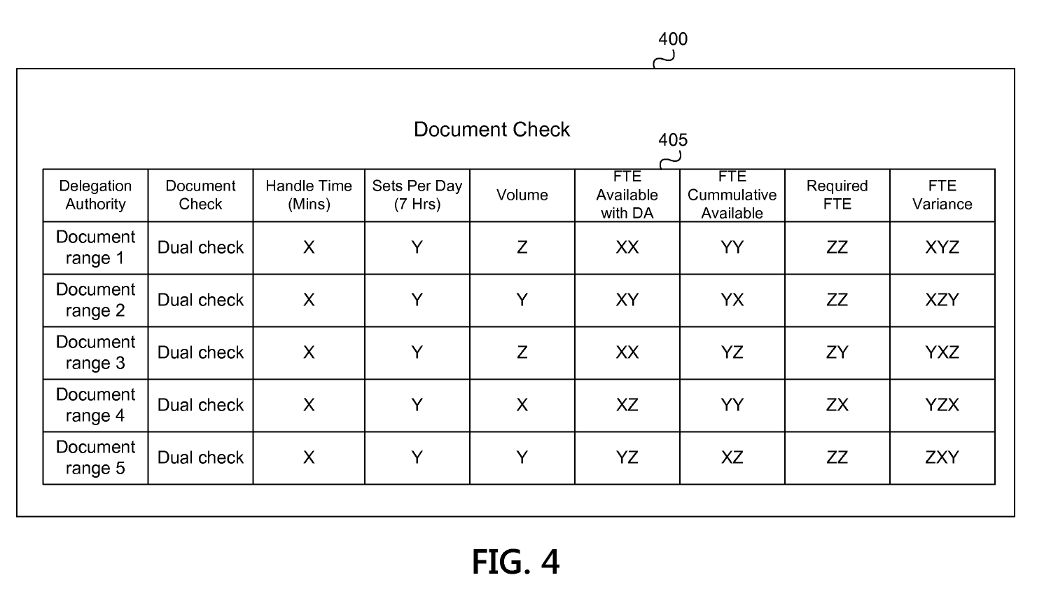

Having described several examples of the processing that may be performed by a computing device in identifying employee capacity issues in some embodiments, an example user interfaces that might be displayed and/or otherwise provided by a computing device, such as computing device 101 and/or system 200, in performing such processing and/or in otherwise identifying employee capacity issues and will now be discussed with respect to FIG. 4.

FIG. 4 illustrates an example of a user interface that may be displayed when providing status information about employee capacity in one or more embodiments. As seen in FIG. 4, in some instances, a computing device implementing one or more aspects of the disclosure (e.g., computing device 101, system 200, and/or the like) may display and/or otherwise provide a user interface 400 that includes a portion in which information about various employee capacity issues can be displayed.

In some arrangements, user interface 400 may include a table 405 that may represent and/or include information that is configured to identify one or more employee capacity issues associated with groups of documents. In particular, table 405 may include information that is used to identify any employee capacity issues with respect to performing a review of a volume of documents having various monetary values. Table 405 may include different categories of data including delegation authority monetary amounts, document check information, predetermined handling times, sets per day, volume of documents, full time equivalence available with DA, full time equivalence cumulative available, required full time equivalence, and full time equivalence variance. In some instances, the value in each of the cells in the full time equivalence variance column of table 405 may, for example, correspond to and/or represent an employee variance for a group of documents having a specific monetary value.

Various aspects described herein may be embodied as a method, an apparatus, or as one or more computer-readable media storing computer-executable instructions. Accordingly, those aspects may take the form of an entirely hardware embodiment, an entirely software embodiment, or an embodiment combining software and hardware aspects. Any and/or all of the method steps described herein may be embodied in computer-executable instructions stored on a computer-readable medium, such as a non-transitory computer readable memory. Additionally or alternatively, any and/or all of the method steps described herein may be embodied in computer-readable instructions stored in the memory of an apparatus that includes one or more processors, such that the apparatus is caused to perform such method steps when the one or more processors execute the computer-readable instructions. In addition, various signals representing data or events as described herein may be transferred between a source and a destination in the form of light and/or electromagnetic waves traveling through signal-conducting media such as metal wires, optical fibers, and/or wireless transmission media (e.g., air and/or space).

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, the steps illustrated in the figures may be performed in other than the recited order, and one or more steps illustrated may be optional in accordance with aspects of the disclosure.

What is claimed is:

1. A method comprising:
categorizing, by a computing device, delegations of authority for a plurality of employees;
grouping, by the computing device, a volume of documents into a plurality of groups by monetary value;
calculating, by the computing device, a required employee capacity to assess each group of documents;
calculating, by the computing device, an actual employee capacity available to assess each group of documents;
comparing, by the computing device, the actual employee capacity with the required employee capacity for each group of documents; and
determining, by the computing device, based on the comparing, whether a difference exists between the actual employee capacity and the required employee capacity for each group of documents.

2. The method of claim 1, further comprising:
in response to determining that a difference exists, enabling, by the computing device, one or more resolution actions.

3. The method of claim 2, wherein enabling the one or more resolution actions includes at least one of: issuing an alert, generating a graphical snapshot of the identified difference between the actual employee capacity and the required employee capacity, suggesting supplemental employee capacity for assessing each group of documents, rescheduling employees to review documents corresponding to a different authorization level, and collecting historical data of any identified difference.

4. The method of claim 1, wherein each group of documents has a corresponding authorization level for assessment.

5. The method of claim 4, wherein the authorization level for each corresponding group of documents cascades to all groups of documents having a monetary value below the corresponding group of documents.

6. The method of claim 1, wherein calculating the required employee capacity is based on one or more predetermined document handling times.

7. The method of claim 6, wherein the one or more predetermined document handling times include one or more values derived from historical data collected by the computing device.

8. One or more non-transitory computer-readable media having computer-executable instructions stored thereon that, when executed by a computing device, cause the computing device to:
categorize delegations of authority for a plurality of employees;
group a volume of documents into a plurality of groups by monetary value;
calculate a required employee capacity to assess each group of documents;
calculate an actual employee capacity available to assess each group of documents;
compare the actual employee capacity with the required employee capacity for each group of documents; and
determine, based on the comparing, whether a difference exists between the actual employee capacity and the required employee capacity for each group of documents.

9. The one or more non-transitory computer readable media of claim 8, having additional computer-executable instructions stored thereon that, when executed by the computing device, further cause the computing device to:
in response to determining that a difference exists, enable, by the computing device, one or more resolution actions.

10. The one or more non-transitory computer readable media of claim 9, wherein enabling the one or more resolution actions includes at least one of: issuing an alert, generating a graphical snapshot of the identified difference between the actual employee capacity and the required employee capacity, rescheduling employees to review documents corresponding to a different authorization level, and identifying a needed supplemental employee capacity for assessing each group of documents.

11. The one or more non-transitory computer readable media of claim 8, wherein each group of documents has a corresponding authorization level for assessment.

12. The one or more non-transitory computer readable media of claim 11, wherein the authorization level for each corresponding group of documents cascades to all groups of documents having a monetary value below the corresponding group of documents.

13. The one or more non-transitory computer readable media of claim 8, wherein calculating the required employee capacity is based on one or more predetermined document handling times.

14. The one or more non-transitory computer readable media of claim 13, wherein the one or more predetermined document handling times include on or more values derived from historical data collected by the computing device.

15. A computing device, comprising:
at least one processor; and
memory storing computer readable instructions that, when executed by the at least one processor, cause the computing device to:
categorize delegations of authority for a plurality of employees;
group a volume of documents into a plurality of groups by monetary value;
calculate a required employee capacity to assess each group of documents;
calculate an actual employee capacity available to assess each group of documents;
compare the actual employee capacity with the required employee capacity for each group of documents; and
determine, based on the comparing, whether a difference exists between the actual employee capacity and the required employee capacity for each group of documents.

16. The computing device of claim 15, wherein the memory stores additional computer readable instructions that, when executed by the at least one processor, further cause the computing device to:
in response to determining that a differences exists, enable, by the computing device, one or more resolution actions.

17. The computing device of claim 16, wherein enabling the one or more resolution actions includes at least one of: issuing an alert, generating a graphical snapshot of the identified difference between the actual employee capacity and the required employee capacity, rescheduling employees to review documents corresponding to a different authorization level, and identifying a needed supplemental employee capacity for assessing each group of documents.

18. The computing device of claim 15, wherein each group of documents has a corresponding authorization level for assessment.

19. The computing device of claim 18, wherein the authorization level for each corresponding group of documents cascades to all groups of documents having a monetary value below the corresponding group of documents.

20. The computing device of claim 15, wherein calculating the required employee capacity is based on one or more predetermined document handling times.

21. The computing device of claim 20, wherein the one or more predetermined document handling times include one or more values derived from historical data collected by the computing device.
